(19) United States
(12) Patent Application Publication
(10) Pub. No.: US 2016/0239710 A1
(43) Pub. Date: Aug. 18, 2016

(54) VISUAL ASSIST SYSTEM AND WEARABLE DEVICE EMPLOYING SAME

(71) Applicant: FIH (HONG KONG) LIMITED, Kowloon (HK)

(72) Inventor: HONG-YI CHEN, New Taipei (TW)

(21) Appl. No.: 14/748,863

(22) Filed: Jun. 24, 2015

(30) Foreign Application Priority Data
Feb. 13, 2015 (TW) 104104865

(51) Int. Cl. G06K 9/00; G06K 9/78; G06K 9/20; G09B 21/00; G06K 9/32

(52) U.S. Cl. CPC G06K 9/00671; G09B 21/006; G06K 9/3241; G06K 9/209; G06K 9/78

(57) ABSTRACT

A visual assist system includes an audio module, a detecting module, an image identifying module, and a processing module. The detecting module detects a distance and a dimension of objects in front of a user of the visual assist system and output detection data. The image identifying module captures images of the objects and identifies the images, and then output identification data. The processing module outputs audio instruction according to the detection data and the identification data. The audio module broadcasts audio according to the audio instruction to indicate to the user the objects' information. A wearable device employing the visual assist system is also provided.

### FIELD

The subject matter herein generally relates to a visual assist system, and particularly relates to a visual assist system and a wearable device employing the visual assist system.

### BACKGROUND

People with weak eyesight need more assistant instruments, such as a walking stick or a navigating instrument with audio indication. However, a limit detecting distance of the walking stick or an unclear audio indication in noise environment may do harm to the user. Therefore, a smarter assist system is needed.

### BRIEF DESCRIPTION OF THE DRAWINGS

Implementations of the present technology will now be described, by way of example only, with reference to the attached figures.

FIG. 1 is an isometric view of an exemplary embodiment of a wearable device.

FIG. 2 is a block diagram of an exemplary embodiment of a visual assist system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

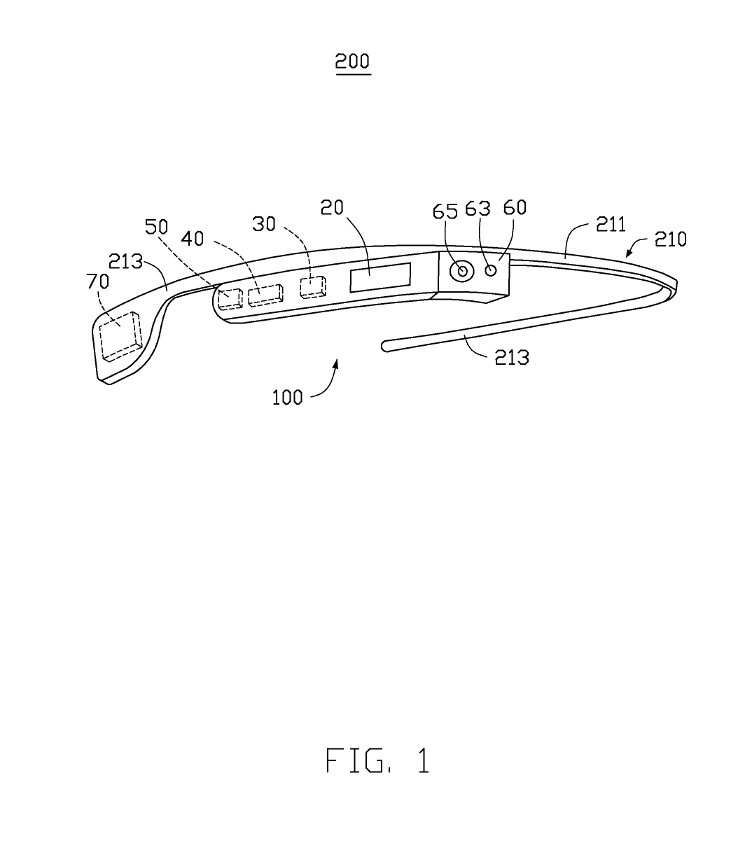

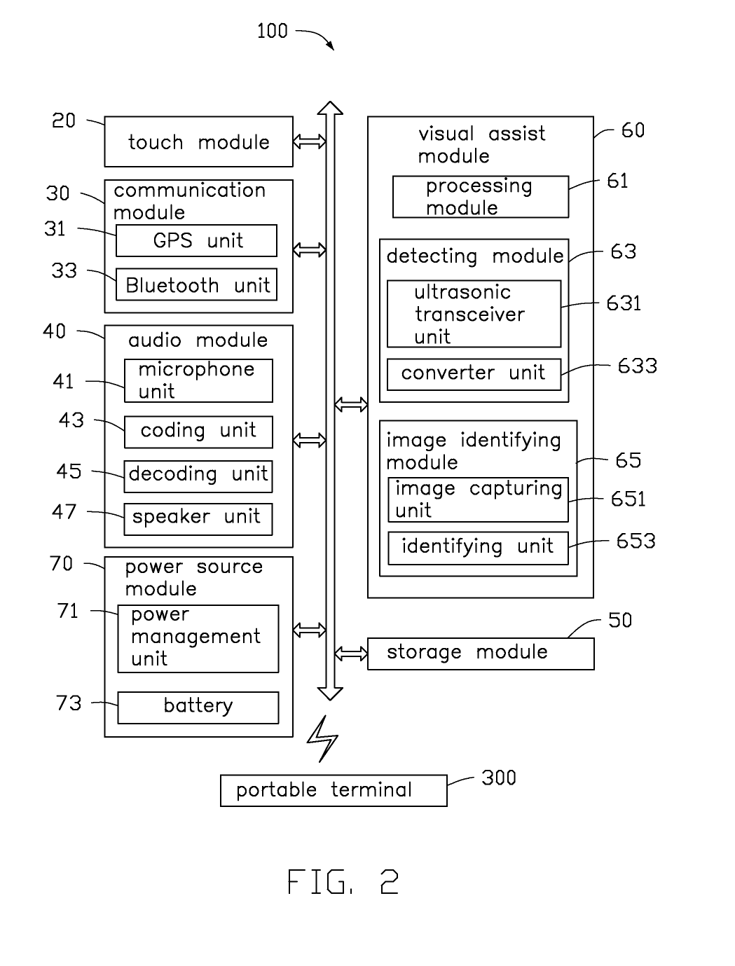

FIGS. 1 and 2 illustrate at least one embodiment of a wearable device 200 applied to people with weak eyesight to help better get into daily life.

The wearable device 200 includes a frame 210 and a visual assist system 100 coupled to the frame 210. The frame 210 includes a support portion 211 and two foldable extending arms 213 coupled to two opposite ends of the support portion 210. The support portion 211 and the extending arms 213 can be supported by a nose and ears of a user.

The visual assist system 100 includes a touch module 20, a communication module 30, an audio module 40, a storage module 50, a visual assist module 60, and a power source module 70. In at least one embodiment, the touch module 20, the communication module 30, the audio module 40, the storage module 50, and the power source module 70 are mounted on one of the extending arms 213. The visual assist module 60 is mounted on the support portion 211.

The touch module 20 is configured to receive user touch command to control the visual assist system 100. The touch module 20 converts the touch command input by the user to instruction code to control the visual assist system 100 to execute a motion corresponding to the instruction code, therefore, to further control a portable terminal 300 via the visual assist system 100. For instance, after establishing communication between the visual assist system 100 and the portable terminal 300, and when the portable terminal 300 has an incoming call, user may slide towards the support portion 211 on the touch module 20 to answer the call. Contrarily, user may slide away from the support portion 211 on the touch module 20 to reject the call.

The communication module 30 is configured to establish communication with the portable terminal 300. The communication module 30 includes a GPS unit 31 and a Bluetooth® unit 33. The GPS unit 31 is configured to locate the wearable device 200 and output the location data. The Bluetooth® unit 33 is configured to establish communication with the portable terminal 300 to exchange data between the visual assist system 100 and the portable terminal 300.

The audio module 40 is configured to input and output audio signal. The audio module 40 includes a microphone unit 41, a coding unit 43, a decoding unit 45, and a speaker unit 47. The microphone unit 41 is configured to receive audio from the user and convert the audio to a first analog audio signal. The coding unit 43 is configured to convert the first analog audio signal to digital audio signal and code the digital signal for transmitting to the portable terminal 300 via the Bluetooth® unit 33. The decoding unit 45 is configured to receive digital audio signal from the portable terminal 300 via the Bluetooth® unit 33 and decode the digital audio signal, and then further convert the digital audio signal to a second analog audio signal for being played by the speaker unit 47.

The storage module 50 is configured to store data, for example touch data of the touch module 20, location data of the communication module 30, audio data of audio module 40, and visual assist data of the visual assist module 60. In addition, the storage module 50 further stores predetermined data, for example image data of traffic instruction, emergency exit information, etc. The visual assist module 60 captures image of the predetermined data and identifies the captured image for indicating the user the environment by broadcasting audio indication by the audio module 40.

The visual assist module 60 is electrically connected to the touch module 20, the communication module 30, the audio module 40, and the storage module 50. The visual assist module 60 is configured to capture image and output corresponding visual assist data. The visual assist module 60 includes a processing module 61, a detecting module 63, and an image identifying module 65. The processing module 61 is configured to control the detecting module 63 and the image identifying module 65 and process data output by the detecting module 63 and the image identifying module 65. The detecting module 63 is configured to detect objects in front of the user of the wearable device 100 and output detection data. The image identifying module 65 is configured to capture images of objects in front of the user and identify the images to output identification data. The detection data and the identification data are stored in the storage module 50. The processing module 61 transmits corresponding audio instruction to the audio module 40 according to the detection data and the identification data, thereby the audio module 40 broadcasts the audio instruction to indicate the user.

The detecting module 63 includes an ultrasonic transceiver unit 631 and a converter unit 633. The ultrasonic transceiver unit 631 is configured to transmit ultrasonic wave to objects in front to detect distance of the object and output distance data. The ultrasonic transceiver unit 631 transmits ultrasonic wave forward and timing begins, the ultrasonic wave travels in the air and returns when meets any objects on the way. The ultrasonic transceiver unit 631 receives the return ultrasonic wave and timing stops. The processing module 61 calculates a distance between the wearable device 200 and the object in front according to a travelling speed of the ultrasonic wave in the air and a time from transmitting the ultrasonic wave to receiving the ultrasonic wave. In at least one embodiment, the ultrasonic transceiver unit 631 may transmit a group of ultrasonic waves to the object due to irregular surface of the object, thereby the ultrasonic transceiver unit 631 may receive a group of distances to increase a detection precision. The converter unit 633 is configured to generate a geometry figure of the object according to the group distances detected by the ultrasonic transceiver unit 631 to obtain a general dimension of the object, and further output dimension data. The processing module 61 outputs corresponding audio instruction to the audio module 40 according to the distance data of the ultrasonic transceiver unit 631 and the dimension data of the converter unit 633 to indicate the user that the distance and dimension of the object via the audio instruction.

The image identifying module 65 includes an image capturing unit 651 and an identifying unit 653. The image capturing unit 651 can be a camera module and configured to capture image data in front of the wearable device 200. The identifying unit 653 is configured to compare the image data captured by the image capturing unit 651 with the predetermined image data stored in the storage module 50 to determine whether equated to the predetermined image data, thereby outputting identifying data. For instance, the storage module 50 stores face feature image data of some frequent contact people of the user. When the user of the wearable device 200 needs to meet one of the frequent contact people, the image capturing unit 651 captures face feature image data of the person in front of the user, the identifying unit 653 compares the captured face feature image data with the face feature image data of the frequent contact people stored in the storage module 50 to determine whether the person is one of the frequent contact people. When the captured face feature image data is equated to the stored face feature image data, the image identifying module 65 outputs a contact person's confirmation information, the processing module 61 transmits audio instruction to the audio module 40 according to the contact person's confirmation information to indicate the user that the person in front is one of the frequent contact people.

The power source module 70 is configured to provide power for the visual assist system 100. The power source module 70 includes a power management unit 71 and a battery 73. The power management unit 71 is a rechargeable circuit unit and configured to be connected to a power adapter via a charger interface for charging the battery 73. The battery 73 is configured to provide power for the touch module 20, the communication module 30, the audio module 40, the storage module 50, and the visual assist module 60.

The wearable device 200 having the visual assist system 100 that uses the detecting module 63 to detect a distance between the user and the object and a dimension of the object, and then the image identifying module 65 captures image and identifies the image of the object, the processing module 61 transmits audio instruction to the audio module 40 according to the detection data of the detecting module 63 and the identification data of the image identifying module 65. Thereby the audio module 40 broadcasts audio according to the audio instruction to indicate the user. Therefore, the people with weak eyesight may use the wearable device 200 to help to determine the environment around the user, which can help user to better adapt to the daily life.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A visual assist system comprising:
a detecting module configured to detect a distance and a dimension of objects in front of a user of the visual assist system and output detection data;
an image identifying module configured to capture images of the objects and identify the images, and then output identification data;
a processing module configured to output audio instruction according to the detection data and the identification data; and
an audio module configured to broadcast audio according to the audio instruction to indicate to the user the objects' information.

2. The visual assist system as claimed in claim 1, wherein the detecting module comprises an ultrasonic transceiver unit and a converter unit, the ultrasonic transceiver unit is configured to transmit a group of ultrasonic waves to the object to detect distances between the user and the object and output distance data; the converter unit is configured to generate a geometry figure of the object according to the group distances detected by the ultrasonic transceiver unit to obtain a general dimension of the object, and further output dimension data.

3. The visual assist system as claimed in claim 1, further comprising a storage module configured to store predetermined image data for the image identifying module and audio data for the audio data.

4. The visual assist system as claimed in claim 3, wherein the image identifying module comprises image capturing unit and an identifying unit, the image capturing unit is configured to capture image data in front of the visual assist system, the identifying unit is configured to compare the image data captured by the image capturing unit with the predetermined image data stored in the storage module to determine whether equated to the predetermined image data, thereby outputting identifying data.

5. The visual assist system as claimed in claim 1, further comprising a communication module, wherein the communication module comprises a GPS unit and a Bluetooth® unit, the GPS unit is configured to locate the user of the visual assist system and output the location data, the Bluetooth® unit is configured to establish communication with a portable device to exchange data between the visual assist system and the portable terminal.

6. The visual assist system as claimed in claim 5, wherein the audio module comprises a microphone unit, a coding unit, a decoding unit, and a speaker unit; the microphone unit is configured to receive audio from the user and convert to a first analog audio signal; the coding unit is configured to convert the first analog audio signal to digital audio signal and code the digital signal for transmitting to the portable terminal via the Bluetooth® unit; the decoding unit is configured to receive digital audio signal from the portable terminal via the Bluetooth® unit and decode the digital audio signal, and then further convert the digital audio signal to a second analog audio signal for being played by the speaker unit.

7. The visual assist system as claimed in claim 5, further comprising a touch module configured to receive user touch command to control the visual assist system, wherein the touch module converts the touch command input by the user to instruction code to control the visual assist system execute a motion corresponding to the instruction code, therefore, to further control the portable terminal via the visual assist system.

8. The visual assist system as claimed in claim 1, further comprising a power source module, wherein the power source module comprises a power management unit and a battery, the power management unit is a rechargeable circuit unit and configured to be connected to a power adapter via a charger interface for charging the battery, the battery is configured to provide power for the visual assist system.

9. A wearable device comprising:
a frame; and
a visual assist system coupled to the frame, the visual assist system comprising:
a detecting module configured to detect a distance and a dimension of objects in front of a user of the visual assist system and output detection data;
an image identifying module configured to capture images of the objects and identify the images, and then output identification data;
a processing module configured to output audio instruction according to the detection data and the identification data; and
an audio module configured to broadcast audio according to the audio instruction to indicate to the user the objects' information.

10. The wearable device as claimed in claim 9, wherein the detecting module comprises an ultrasonic transceiver unit and a converter unit, the ultrasonic transceiver unit is configured to transmit a group of ultrasonic waves to the object to detect distances between the user and the object and output distance data; the converter unit is configured to generate a geometry figure of the object according to the group distances detected by the ultrasonic transceiver unit to obtain a general dimension of the object, and further output dimension data.

11. The wearable device as claimed in claim 9, further comprising a storage module configured to store predetermined image data for the image identifying module and audio data for the audio data.

12. The wearable device as claimed in claim 11, wherein the image identifying module comprises image capturing unit and an identifying unit, the image capturing unit is configured to capture image data in front of the visual assist system, the identifying unit is configured to compare the image data captured by the image capturing unit with the predetermined image data stored in the storage module to determine whether equated to the predetermined image data, thereby outputting identifying data.

13. The wearable device as claimed in claim 9, further comprising a communication module, wherein the communication module comprises a GPS unit and a Bluetooth® unit, the GPS unit is configured to locate the user of the visual assist system and output the location data, the Bluetooth® unit is configured to establish communication with a portable device to exchange data between the visual assist system and the portable terminal.

14. The wearable device as claimed in claim 13, wherein the audio module comprises a microphone unit, a coding unit, a decoding unit, and a speaker unit; the microphone unit is configured to receive audio from the user and convert to a first analog audio signal; the coding unit is configured to convert the first analog audio signal to digital audio signal and code the digital signal for transmitting to the portable terminal via the Bluetooth® unit; the decoding unit is configured to receive digital audio signal from the portable terminal via the Bluetooth unit and decode the digital audio signal, and then further convert the digital audio signal to a second analog audio signal for being played by the speaker unit.

15. The wearable device as claimed in claim 13, further comprising a touch module configured to receive user touch command to control the visual assist system, wherein the touch module converts the touch command input by the user to instruction code to control the visual assist system execute a motion corresponding to the instruction code, therefore, to further control the portable terminal via the visual assist system.

16. The wearable device as claimed in claim 9, further comprising a power source module, wherein the power source module comprises a power management unit and a battery, the power management unit is a rechargeable circuit unit and configured to be connected to a power adapter via a charger interface for charging the battery, the battery is configured to provide power for the visual assist system.

17. The wearable device as claimed in claim 9, wherein the frame comprises a support portion and two foldable extending arms coupled to two opposite ends of the support portion, the support portion and the extending arms are supported by a nose and ears of a user.
